(19) United States
(12) Patent Application Publication
(10) Pub. No.: US 2005/0273202 A1
(43) Pub. Date: Dec. 8, 2005

(54) Method and device for improving the positioning accuracy of a manipulator

(76) Inventor: Rainer Bischoff, Augsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 11/141,977

(22) Filed: Jun. 1, 2005

(30) Foreign Application Priority Data
Jun. 2, 2004 (DE) 10 2004 026814.2

(51) Int. Cl. G06F 19/00

(52) U.S. Cl. 700/263

(57) ABSTRACT

A method for improving the positioning accuracy of a manipulator, such as a multiaxial or multiaxle industrial robot is proposed, by producing at least one absolutely accurate model of the manipulator for the control thereof. According to the invention, for producing the absolutely accurate model, firstly a pose of the manipulator is determined by an external measuring system, then deviations of the determined pose from a preset pose are detected, after which, as a function of the external measuring system and for minimizing deviations, the manipulator is moved into an end pose substantially corresponding to the preset pose and finally internal position values of the manipulator in the end pose are used for parametrizing the absolutely accurate model. In this way the invention improves the absolutely accurate measurement of robots, particularly with regards to accuracy and thus permits the replacement of a random, absolutely accurate robot in a working cell by another such robot.

### FIELD OF THE INVENTION

The invention relates to a method for improving the positioning accuracy of a manipulator, such as a multiaxial or multiaxle industrial robot, in which a pose of the manipulator is determined by an external measuring system and deviations from the determined pose from a preset pose are detected. The invention also relates to a device for determining a control model for a manipulator, such as a multiaxial or multiaxle industrial robot, having an external measuring system for determining at least one degree of freedom of a pose of the manipulator and with comparator means for detecting deviations between the determined pose and the preset pose.

### BACKGROUND OF THE INVENTION

In order to improve the positioning accuracy of manipulators, particularly multiaxial industrial robots, efforts were made in the past to produce ever more accurate models of the manipulators. The parameters of such models are determined during a calibration process, which is typically performed a single time by the manipulator manufacturer. Typically an auxiliary means is fixed to a hand flange of the robot which permits an accurate determination of the location, i.e. a position and orientation, normally and hereinafter referred to as “pose” of the flange in space. Use is e.g. made of reference plates with known features detectable by a camera or laser tracking system. Alternatively use is made of other measuring systems known to the expert, such as filament or wire measuring systems, etc.

As a result of regularly occurring impressions, e.g. elasticities of transmissions and structural elements of the robot, as well as the lack of dimensional stability thereof, the aforementioned external, highly accurate position measurement of the flange yields a different value to a parallel performed internal measurement of position values of the manipulator by means of angle generating means integrated in its joints linked with a subsequent model calculation, namely a so-called forward transformation. The deviations derived from the thus established position difference at in each case different locations of the working area are subsequently used for determining a so-called “absolutely accurate robot model”, which is significantly more accurate than a theoretical “standard model” of the robot. In this way there is a reduction of the absolute positioning accuracy of a multiaxial industrial robot from a few millimetres when using the standard model to less than one millimetre when using an absolutely accurate robot model.

The known methods and devices of the aforementioned type involve the determination of the above-described absolute accuracy taking place in the following way. On the hand flange of the robot is placed a test plate, whose pose, as mentioned hereinbefore, is detected by an external measuring system. A control device regularly provided for controlling the manipulator receives by means of an internal robot measuring system (angle measuring means on the robot axes) and subsequent model calculations (forward transformation) information is obtained to the effect that the test plate is located in a deviating pose. On the basis of said deviations, the control device or an external computer subsequently determine by extrapolation at what point in space the test plate would have to be positioned in order, whilst assuming identical deviations at this point, to actually assume a pose corresponding to that calculated by the external measuring system.

In the above-described, known method, consequently the absolutely accurate robot model is determined by an extrapolation of axial angles. However, there is no determination by measurement of the particular axial angle difference which must be cut in in operation in order to assume a desired pose in space.

As it is not possible during the measurement to advance to all points of the working area of a robot, said working area is covered with measurement points distributed as uniformly as possible. If during subsequent robot operation there is an advance to points in space which were not measured, interpolation takes place between the measured space points. Absolutely accurate robot models are in a position to transform such interpolation specifications for the entire working area into a calculating or computing specification adding an offset to all the axial angles ordered by a robot control and which serves to bring about an optimum matching of the path points moved up to by the robot control with the actually desired path points in space.

Absolutely accurate robots are more particularly used if robot control programs are produced by offline programming systems and are subsequently used in a real robot without complicated afterteaching. Another field of use of absolutely accurate robots is in cooperation between several such robots, because e.g. during the joint transportation of a workpiece by two robots even the very smallest pose deviations can have serious consequences, e.g. the bending or breaking of the workpiece.

Absolutely accurate robots are nowadays more expensive than standard robots, because the determination of model parameters of the absolutely accurate robot model is very time consuming. Moreover, it has hitherto been necessary even in the case of an absolutely accurate robot, to afterteach path points in the specific application with respect to the known methods and devices due to the indicated extrapolation method always containing an inherent residual imprecision. In the past this has more particularly led to the need for reteaching all the path points of a specific robot use particularly on replacing a robot of one manufacturer by a successor model or a comparable robot of another manufacturer, because quality characteristics of the two robots differ too much due to different designs and the basic models used. However, such a replacement is desired for economic reasons, e.g. for increasing production by shorter cycle times.

The problem of the invention is to give a method and a device in which, whilst avoiding the aforementioned disadvantages, make it possible to improve the positioning accuracy of manipulators based on absolutely accurate control models for the manipulator, so that in particular it is possible to replace a random robot in a robot cell by another robot and also leads to an improved cooperation between the robots.

### SUMMARY OF THE INVENTION

In the case of a method of the aforementioned type, the set problem is solved in that for producing an absolutely accurate model
as a function of the external measuring system and for minimizing deviations, the manipulator is moved into an end pose substantially corresponding to the preset pose and
subsequently internal position values of the manipulator in the end pose are used for parametrizing the absolutely accurate model.

The set problem is also solved by a device for determining a control model for a manipulator, such as a multiaxial industrial robot, having an external measuring system for determining at least one degree of freedom of a pose of the manipulator and with comparator means for detecting deviations between the determined pose and the preset pose, also having:
first storage means for storing a preset pose of the manipulator,
control means for moving the manipulator as a function of the external measuring system into an end pose and whilst minimizing deviations and
calculating means for determining parameters of the control model from internal position values of the manipulator in the end pose and measured values of the external measuring system.

Thus, according to the invention, compared with the prior art, a control device of the manipulator is coupled with an external measuring system, so that the control device can derive from the measured information how it must move the manipulator or a test plate positioned on the hand flange of a robot, in order to bring the same to a previously defined position in space. A decisive difference of the method according to the invention compared with the hitherto known methods is consequently that a position to be moved up to is preset not in robot coordinates (internal position values), but in measuring system coordinates (external measured values). In the known method the manipulator is moved to a point in space and on the basis of internal position values the control device “believes” that it is at the preset point in space. The actual pose is then determined with the aid of the external measuring system. The difference between the internal and external measurements is used in order to determine an offset to be added to the planned axial angle compensating in a local manner the deviation. However, the inventive method proposed supplies an improved absolute accuracy. The measurement objects can be planar or of a random 3-dimensional nature, but have edges perceptible to an image processor allowing a precise determination of the position of the measurement objects in the image.

According to a further development of the inventive method, pose determination by the external measuring system takes place optically. Correspondingly the device according to the invention has an external measuring system in the form of an optical measuring system. It is in particular possible to use per se known measuring systems, such as camera or laser tracking systems. Evaluation takes place in value-continuous manner.

In an extremely preferred development of the inventive device, the external measuring system is a stereo image processing system. Thus, by means of an inventive device it is possible to determine all the degrees of freedom of a pose of the manipulator in one measuring process with the external measuring system.

According to the invention, in highly preferred manner for producing an absolutely accurate model of the manipulator, preferably the manipulator is moved until the end pose and the preset pose coincide within the preset deviation tolerances. To this end the external measuring system is part of a control loop in order to minimize the deviations between the actual and desired poses and to move the robot into a desired, preset pose. The robot is controlled in a pose preset by an external measuring system. For this purpose precise, value-continuous measurements of the external measuring system are carried out and used for performing the control. The control takes place with a view to minimizing an error between the desired and actual poses, the control in preferred manner taking place in image-based form.

Ideally the poses advanced to for pose determinations according to the invention are those poses which the manipulator must regularly move up to during its operation. However, the measurement of the entire working area is neither economically appropriate, nor practicable. However, a single absolutely accurate model is not adequate for the entire working area of a manipulator. Thus, according to the invention, in a method of the aforementioned type, it is proposed for solving the set problem that in each case associated absolutely accurate models are produced for a plurality of working area zones of the manipulator. Thus, the robot working area is subdivided into several working areas to increase accuracy. For each of these and independently of one another an absolutely accurate model is produced, which is naturally better in its associated partial working area than a model for the entire working area.

In such a development of the inventive method measurement only takes place of the particular zone or zones within the attainable working area of the manipulator to which an advance actually takes place in operation. For each of these zones an associated, absolutely accurate model is administered according to the invention and between which it is possible to switch as necessary. Preferably, during manipulator operation, as a function of a pose a choice is made between several, absolutely accurate models. This count preferably also takes place on calibration.

According to a further development of the inventive method, the detected parameters of the absolutely accurate model or models are stored in a control device of the manipulator and used for control purposes when necessary. Generally parameters of absolutely accurate robot models are filed in nonvolatile manner in a control device of the manipulator. It is normally impossible for a plant operator to determine these parameters, because the fundamental, absolutely accurate robot model is not known.

In order to allow plant operators to parametrize said model, according to the invention a simple interface is to be made available for robot control and an algorithm for calculating model parameters. By means of said interface a points list is made available to said algorithm (which can also run on an external computer) which must at least contain as many points (informations) to enable a known optimization method to determine the number of unknown parameters. The points list comprises internal position values of the manipulator and also measured values of an external robot pose determination associated with the first mentioned values.

According to a further development of the inventive method, the internal position values are transformed by the memories into a pose of the manipulator. It is also possible to convert the externally determined pose values into axial positions (reverse transformation).

According to corresponding further developments of the inventive device, the latter has second storage means for storing external measured values and internal position values. There can also be transforming means for transforming internal position values into a pose of the manipulator.

### BRIEF DESCRIPTION OF THE DRAWINGS

Further advantages and characteristics of the invention can be gathered from the following description of an embodiment with reference to the attached drawings, wherein show:

FIG. 1a Diagrammatically a manipulator in the form of a multiaxial industrial robot and an external measuring system.

FIG. 1b A block diagram of an inventive device.

FIG. 2 Diagrammatically a test plate located on a robot hand flange.

FIG. 3 Diagrammatically a deviation minimization performed during the inventive method.

FIG. 4 An exemplified method sequence for determining the parameters of an absolutely accurate robot according to the invention.

### DETAILED DESCRIPTION OF THE DRAWINGS

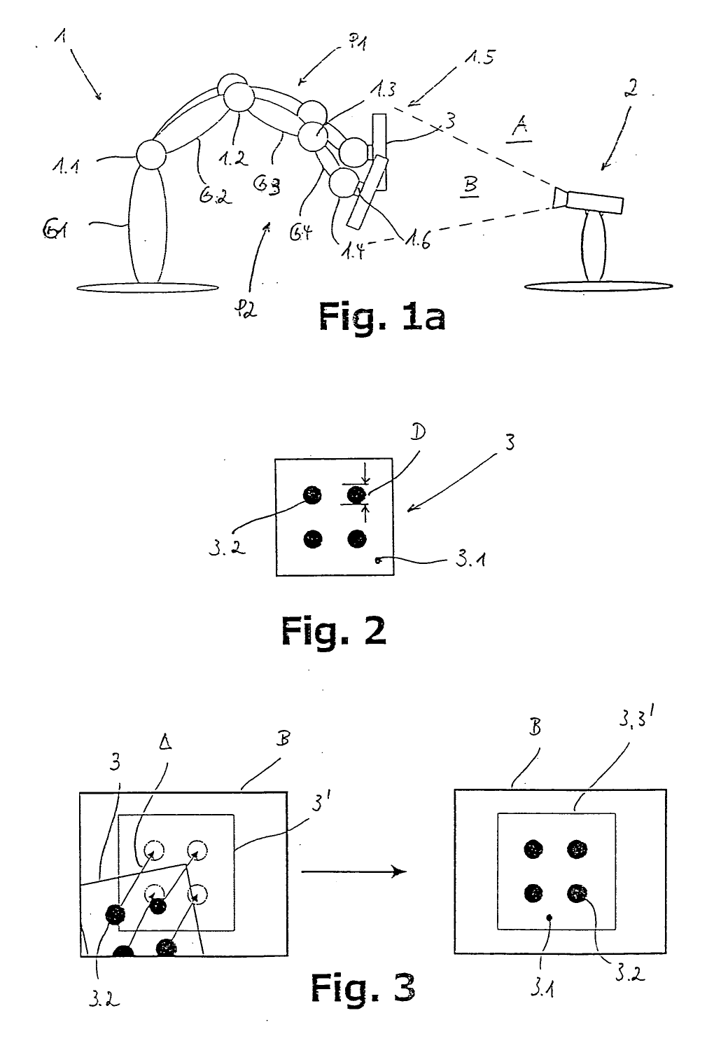

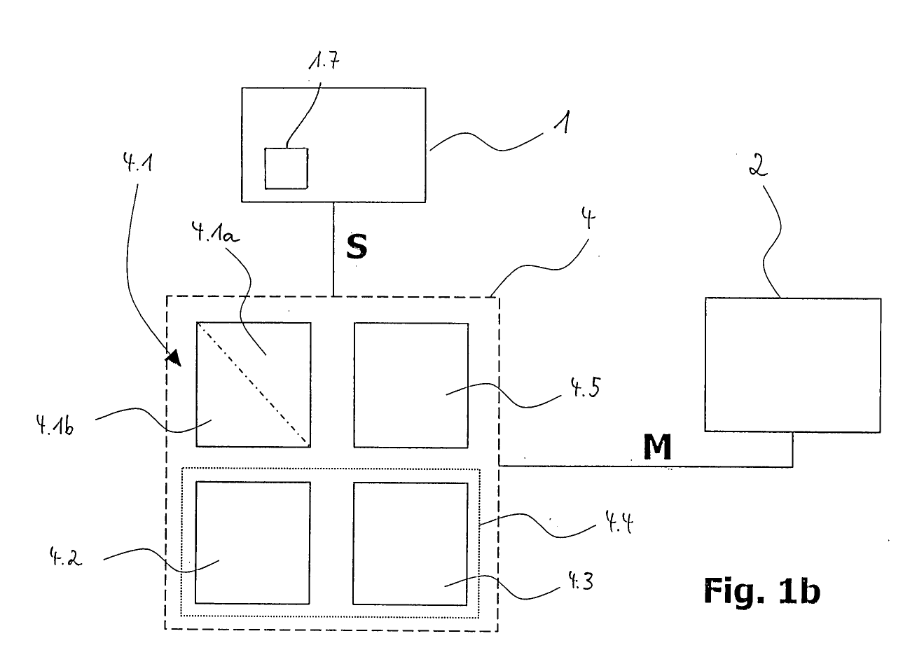

FIG. 1a shows a manipulator in the form of a multiaxial or multiaxle industrial robot and also an external measuring system 2, here in the form of an optical camera system, cooperating therewith in its working area A.

The robot 1 has numerous robot members or limbs G1 to G4 (only diagrammatically shown in the drawings), which are interconnected by the corresponding joints 1.1 to 1.4. On a distal end 1.5 of an arm of the robot 1 formed from the members G1 to G4 is located a hand flange 1.6 to which is fixed a test plate 3 (cf. FIG. 2). As is shown further down in FIG. 1b, the robot 1 also has an internal measuring system 1.7 for position values of the robot 1, e.g. in the form of angle measuring means contained in the robot joints 1.1 to 1.4.

FIG. 1a shows the robot 1 in two poses P1, P2. Pose P1 (continuous line in FIG. 1a) designates an actual pose which can be determined according to the invention with the aid of the external measuring system 2. Pose P2 (dotted line in FIG. 1a) designates the particular pose in which the robot 1 believes it is on the basis of the internal measuring system, such as angle measuring means present in its joints 1.1 to 1.4.

For measuring the poses of the robot 1, the external measuring system 2 has a measuring range defined in FIG. 1a by its range limits (broken lines). Within said range B the external measuring system can determine the pose of the test plate 3 and from it can be determined with the aid of known methods the robot pose P1.

By means of a block diagram, FIG. 1b shows the inventive cooperation of robot 1 or a control device 4 connected thereto and the external measuring system 2 (cf. FIG. 1a). The control device 4 is connected to the robot 1, particularly for the movement control thereof by control signals S. There is also a connection from control device 4 to the external measuring system 2 by means of which pose measured values M can be transmitted from the external measuring system 2 to the control device 4 and conversely control instructions for performing a measuring process. In place of the robot control it is also possible for a further computer (master computer) to collect measured values from the measuring system and command the robot control.

According to FIG. 1b the control device 4 incorporates at least storage means 4.1, which according to the embodiment shown are subdivided functionally, but not necessarily in hardware-based manner into first storage means 4.1 and second storage means 4.1b (dot-dash line in FIG. 1b). The storage means 4.1 can in particular be a nonvolatile mass memory.

The control device 4 also incorporates comparator means 4.2 and calculating means 4.3, which according to the embodiment shown are in the form of a hardware unit, namely a microprocessor 4.4 (dotted line in FIG. 1b). In addition, it is also possible to see control means 4.5, which can be constructed as a unit with the comparator means 4.2 and calculating means 4.3.

The functions of the individual components of the control device 4 within the scope of the present invention will be explained in greater detail hereinafter.

FIG. 2 diagrammatically shows a front view of the test plate 3 of FIG. 1a, roughly from the viewing direction of the external measuring system 2. In the embodiment shown the test plate 3 is square and is provided on its front side 3.1 with a plurality of circular markings 3.2, which are specifically arranged in the manner of the eyes or dots of a dice in order to illustrate the number four in the square. The method functions independently of the way in which the points or dots are arranged, these being selected because they can then be easily detected by image processing. The markings 3.2 all have the same diameter D. Thus, by means of the absolute position of the test plate 3 determined by the external measuring system 2 (FIG. 1a) as a result of absolute positions of the markings 3.2 or apparent changes to the diameter D between individual markings, it is possible to determine a pose P1 of the robot 1 and is inventively used for improving the positioning accuracy or for producing an absolutely accurate model of the robot 1.

This is diagrammatically shown in FIG. 3. The rectangles in FIG. 3 in each case designate the measuring range B of the external measuring system 2 (cf. FIG. 1a). In the left and right-hand parts of FIG. 3 is in each case shown an image recorded by the camera of the external measuring system 2. In the left-hand part of FIG. 3, in addition to the (real) test plate 3 is indicated a further, virtual test plate 3′ (dotted), which symbolizes a preset pose of the robot 1, i.e. a pose into which the robot 1 or the test plate 3 is to be moved as a function of the control means 4.5 in the control device 4 (FIG. 1b). The arrows in the left-hand part of FIG. 3 symbolize deviations Δ of the actual pose (test plate 3) from the preset pose (test plate 3′), as are determined in the embodiment shown by the comparator means 4.2 of the control device 4, after the external measuring system 2 has transmitted its measurement data M to the control device 4 and as shown in FIG. 1b. The markings 3.2 on test plate 3 are shown in the left-hand part of FIG. 3, particularly with different diameters, so that by appropriate image processing of the measurement data M from measuring range B of the external measuring system 2 in comparator means 4.2, set up from the software standpoint for this purpose, of control device 4, it is possible to determine deviations in all degrees of freedom (here six) of robot 1. The thus determined deviations A are subsequently used by the control means 4.5 of control device 4 for moving the robot 1 by means of suitable control signals S into an end pose in which the real test plate 3 and the virtual test plate 3′ or their images coincide, apart from a deviation tolerance preset by the control device 4, i.e. except for a tolerated deviation, the robot 1 is in the preset pose and specifically in the embodiment shown in the preset pose stored in the first storage means 4.1a of control device 4. This is shown in the right-hand part of FIG. 3, the remaining deviations not being detectable.

When, according to the invention, a robot end pose has been reached by minimizing deviation Δ, the calculating means 4.3, which have been suitably set up from the software standpoint, of the control device 4 determine parameters of an absolutely accurate control model of the robot 1 from the measured values M of the external measuring system 2 and from internal position values of the robot 1 in the end pose made available in the control device 4 by the internal measuring system 1.7 of robot 1 (FIG. 1b). Moreover, in the embodiment shown, the external measured values M of the external measuring system 2 and the internal position values 1.7 of the robot 1 are permanently filed in the second storage means 4.1b of control device 4 in the form of points lists (see below). The internal position values of the robot 1 are converted, preferably by the calculating means 4.3, which consequently function as transforming means, into a pose of robot 1 prior to storage. This takes place in a manner known to the expert by so-called forward transformation.

As stated, by means of internal robot position values in the end pose, the calculating means 4.3 determine a parametrization of an absolutely accurate robot model. According to the invention this can take place separately for different zones of the working area A of robot 1 with in each case corresponding measurement ranges B of the external sensor system 2. The thus determined, absolutely accurate robot models can, according to the invention, be filed in nonvolatile manner in the storage means 4.1 of the control device and as required and as a function of the current working area of the robot 1 can be controlled and used from the control standpoint for controlling robot 1. However, additionally or alternatively it is also possible to file as such, i.e. in unprocessed, nonvolatile manner in the storage means 4.1 point lists generated during the measurement processes, namely a measurement point list for internal position values of the robot and for external pose determinations by the external measuring system, so that on starting up the control device 4, i.e. during an initializing phase of said device 4, the corresponding model parameters can be determined in current manner from the point lists. This is easily possible, provided that a reference of the measured values to a point present in the control device 4, i.e. a programmed path point of the robot 1 can be made, e.g. by storing a corresponding data item together with the point lists in the storage means 4.1.

In said point lists, joint angles advanced to by the control or the associated poses of a test plate are stored in a first column in the manner seen by the robot control (e.g. in the form of X, Y, Z, A, B, C values of the robot flange or axial angles A1, A2, A3, A4, A5, A6). In a second column are filed measured values of an external measuring system as the actual “true” poses, which are e.g. determined with the aid of an external measuring system, such as a test plate on the flange and stored in the form of X, Y, Z, A, B, C values (test plate pose in space) or values accepted by the model calculation algorithm (e.g. length in a type of wire measuring system) or values already converted to the flange pose, if the latter is possible. Each row or line then contains both the measured values measured by the robot control and also the external measured values associated therewith. The external measured values need not correspond to the robot poses, but can be present in a format given by the measuring system, e.g. the length and angle of a wire in a wire measuring system. On reading said measurement point list from the second column, the robot control will calculate the necessary poses in order to be able to match the internal and external measurements. It is also possible to interpose a measuring device control which carries out said conversion process. A robot operator must be placed in a position to generate point lists with a measuring system suitable for his purposes placing a robot control in a position to determine the parameters of the absolutely accurate robot model. Generally the entire points list constitutes input parameters for the model calculating algorithm and an optimization calculation is performed with respect to all the measured values.

Thus, according to the invention, storage takes place of the points in space advanced to during the measuring process by control device 4, in each case represented by the position and orientation of the hand flange 1.6 of the robot 1 or test plate 3, as obtained from the internal position values of the robot 1 and optionally corresponding model knowledge (forward transformation) and on the other the points in space determined by the external measuring system 2 and which are actually advanced to, i.e. the true positions and orientations of the hand flange 1.6 or test plate 3. According to the invention, various different measuring systems are suitable for said measuring processes, provided that they supply such a points list. In optimum manner, for each measuring process there are all six degrees of freedom in space, e.g. when using as the external measuring system a stereo image processing system. In the least favourable case there is only a single degree of freedom per measurement, e.g. when using a wire measuring system, which merely determines the length of a wire between a fixed point and the flange 1.6 or test plate 3. According to the invention, then there would have to be a correspondingly large number of measurements in order to be able to determine all the parameters of the absolutely accurate robot model.

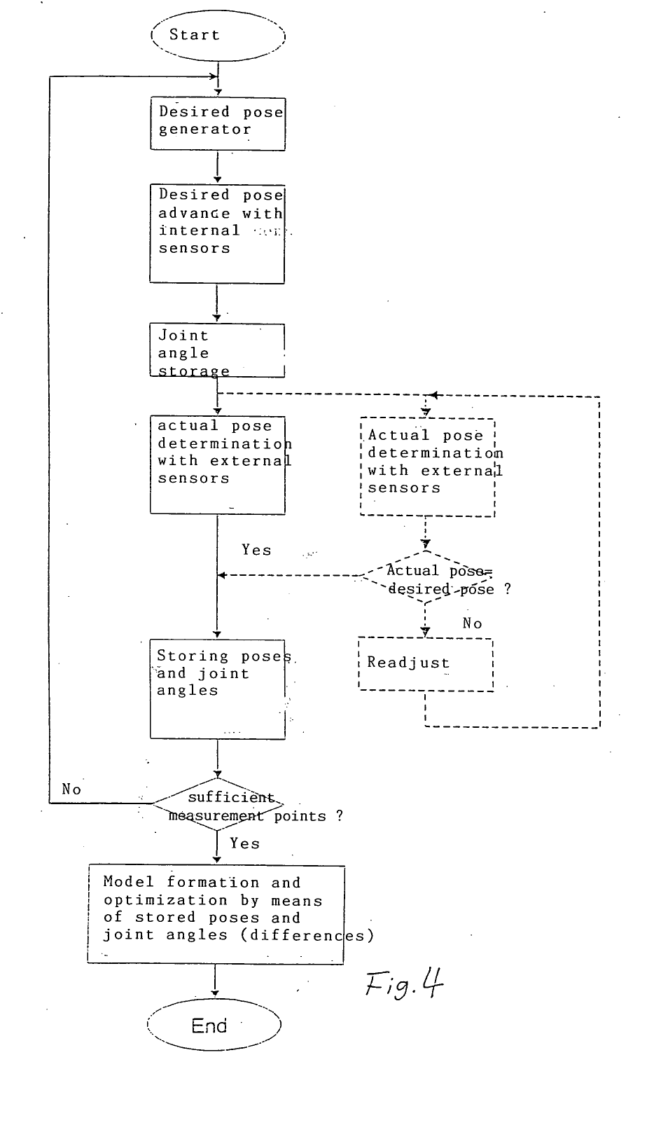

FIG. 4 shows an exemplified method sequence for determining the parameters of an absolutely accurate robot using an external measuring system and which is able to determine the robot pose in all degrees of freedom (e.g. with the aid of an optical system).

Continuous lines indicate a method sequence assumed as known, whereas broken lines indicate the method sequence to which advance can take place in different desired poses during the model parameter finding process with a given, toleratable accuracy. The desired accuracy is obtained by means of a regulation to previously generated desired poses. For each desired pose to be advanced to, by means of an external position determination measuring system, the current, true pose is determined. This is adapted (readjusted) until the robot is at the desired pose. The joint angle deviation at the pose measured by means of internal sensors and the initially set (=assumed) pose compared with the (=true) pose measured and set by means of external sensors is used for parametrizing the absolutely accurate robot model.

If the true actual pose (6 DOF) cannot be directly determined from a single desired positioning process and subsequent measuring process, there can be several positioning processes and measuring processes (e.g. with a wire measuring system), before in a subsequent modelling and optimizing process with the aid of all the recorded measured quantities the parameters of the absolutely accurate robot model are determined.

The “servoing” method can also be used with measuring systems which are unable to determine the pose in one measuring process. In this case there would be no 6 D pose readjustment, but instead the relevant measurement quantities (e.g. wire length and angle) would be readjusted until they corresponded to the aforementioned toleratable accuracy of the “desired measured quantities” generated by the pose generator.

1. Method for improving the positioning accuracy of a manipulator, such as a multiaxial industrial robot, a manipulator pose being determined by an external measuring system and deviations of the determined pose from a preset pose are detected, characterized in that for producing at least one absolutely accurate model of the manipulator for the control thereof
as a function of the external measuring system for minimizing deviations the manipulator is moved into an end pose substantially corresponding to the preset pose and
subsequently internal position values of the manipulator in the end pose are used for parametrizing the absolutely accurate model.

2. Method according to claim 1, wherein the manipulator is moved until the end pose and the preset pose coincide within the scope of preset deviation tolerances.

3. Method for improving the positioning accuracy of a manipulator, such as a multiaxial industrial robot, by producing at least one absolutely accurate model of the manipulator for controlling the same, particularly according to either of the claims 1 and 2, wherein for a plurality of working area zones of the manipulator in each case associated, absolutely accurate models are produced.

4. Method according to claim 3, wherein during the operation of the manipulator and as a function of a pose thereof, a selection is made between several, absolutely accurate models.

5. Method according to claim 1, wherein determined parameters of the absolutely accurate model or models are stored in a control device of the manipulator and, when required, used for control purposes.

6. Method according to claim 1, wherein during the measuring process in connection with model production generated measurement point lists for internal position values of the manipulator and for external pose determinations are stored in a control device of the manipulator and, as required, parameters of the absolutely accurate model or models are determined from the measurement point lists.

7. Method according to claim 6, wherein externally determined poses are transformed into internal position values.

8. Method according to claim 6, wherein model parameter determination takes place with the aid of an optimizing method which takes account of the measured values of several measured poses or position values.

9. Method according to claim 6, wherein the internal position values are transformed into a manipulator pose prior to storage.

10. Method according to claim 1, wherein pose determination takes place optically through the external measuring system.

11. Device for determining a control model for a manipulator, such as a multiaxial industrial robot, with an external measuring system for determining at least one degree of freedom of a pose of the manipulator and with comparator means for detecting deviations between the determined pose and the preset pose, also having:
first storage means for storing a preset pose of the manipulator,
control means for moving the manipulator into an end pose and whilst minimizing deviations, as a function of the external measuring system, and
calculating means for determining parameters of the control model from internal position values of the manipulator in the end pose and measured values of the external measuring system

12. Device according to claim 11, characterized by second storage means for storing the external measured values and internal position values.

13. Device according to claim 11, characterized by transforming means for transforming the internal position values into a pose of the manipulator and vice versa.

14. Device according to claim 11, wherein the external measuring system for determining all the degrees of freedom of a pose of the manipulator is formed in a measuring process.

15. Device according to claim 11, wherein the external measuring system is an optical measuring system.

16. Device according to claim 11, wherein the external measuring system is a stereo image processing system.
